(19) United States
(12) Patent Application Publication
(10) Pub. No.: US 2007/0260886 A1
(43) Pub. Date: Nov. 8, 2007

(54) Biometric authentication device having machine-readable-zone (MRZ) reading functionality and method for implementing same

(75) Inventor: Guy Dufour, Saint-Nicolas (CA)

Correspondence Address: FETHERSTONHAUGH - SMART & BIGGAR, 1000 DE LA GAUCHETIERE WEST, SUITE 3300, MONTREAL, QC, H3B 4W5, CA

(73) Assignee: LABCAL TECHNOLOGIES INC.

(21) Appl. No.: 11/415,232

(22) Filed: May 2, 2006

(51) Int. Cl. H04L 9/00

(52) U.S. Cl. 713/186

(57) ABSTRACT

A biometric authentication device and associated method for providing authentication information associated to a person. The device receives a live biometric signal and identification information associated to the person. The identification information may be manually provided of may be obtained from a machine readable zone located on a medium carried by the person. The device processes the identification information to derive access information that is then used to extract information stored on an electronic chip associated to the person. The device then derives authentication information associated to the person at least in part on the basis of the information stored on the electronic chip and the live biometric signal and releases a signal conveying the authentication information. Advantageously, the device allows, for example, a user to assess whether the person carrying a given medium (such as a passport) is the owner of that medium.

### FIELD OF THE INVENTION

The present invention relates to the field of biometric authentication methods and devices for generating authentication information associated to a person. More specifically, the present invention relates to biometric authentication devices capable of obtaining identification information from an identification document, and using that identification information to extract stored information from an electronic chip in order to authenticate the person associated to the identification document.

### BACKGROUND

In the specific context of travelling across borders, travelers are required to carry with them some sort of identification documentation, which has traditionally been a paper passport. In many countries, new passports and other types of identification documentation are now equipped with an electronic chip that is either embedded in a smart card or in other mediums such as paper documentation. Such electronic chips generally store a plurality of information elements associated to the traveler and often include biometric information.

In recent years, the International Civil Aviation Organization (ICAO) has put forth a series of standards regarding the use of biometric information within travel documents. These standards describe how an electronic chip can be embedded in a travel document, and how RF communication can be established with this chip. For example, the ICAO has specified that certain information contained in travel documents, such as passport numbers, for example, should be used as access numbers (PIN) for unlocking associated electronic chips. This provides an additional security measure, since the information contained on the electronic chip cannot be accessed without using information located on the travel document.

When screening a person crossing a border, it is desirable that the screening processes require as little human input as possible so as to prevent both time consuming procedures, and human error. A deficiency with existing screening devices, both portable and non-portable, is that they have traditionally used the information located in the identification document, including the graphics imbedded therein, only to verify the integrity of the identification document. In other words, the verification has typically been limited to verifying whether the identification document is a forgery, or has been tampered with. However, such screening devices do not provide suitable functionality for verifying whether the identification document actually belongs to the person who is presenting it.

The above deficiency associated with devices that verify identification documents are not limited to systems and devices used at border crossings. Such deficiencies may also exist in secure buildings that have restricted areas. In fact, any access control type of application relying on identification documents is subject to the above mentioned deficiency.

In light of the above, it can be seen that there is a need in the industry for an improved method and device for authenticating individuals presenting identification documentation at border crossings, or other restricted areas, that alleviates, at least in part the deficiencies of existing systems.

### SUMMARY

In accordance with a broad aspect, the present invention provides a biometric authentication device comprising a first interface, a second interface, a third interface, a processing unit and an output. The first interface is for receiving a live biometric signal associated to a person. The second interface is for receiving information from an electronic chip associated to the person and the third interface for obtaining a signal derived from a machine readable zone located on a medium carried by the person. The processing unit is operative for processing the signal derived from the machine readable zone located on the medium carried by the person to derive access information and for extracting information stored on the electronic chip at least in part on the basis of the access information. The processing unit is also operative for deriving authentication information associated to the person at least in part on the basis of the information stored on the electronic chip and the live biometric signal. The output is for releasing a signal conveying the authentication information.

In accordance with a specific implementation, the medium associated to the person can be one of an identification document, a passport, a driver's license, a travel document, a travel visa and a credit card or any other medium allowing identifying a person. In such specific implementations, the machine readable zone on the medium comprises one of a passport number, a visa number, a driver's license number, a bar code, a credit card number or any other identifier allowing identifying a person.

Advantageously, the biometric authentication device in accordance with the invention may allow a user to assess whether the person carrying a given medium, such as a passport, is the owner of that medium.

In accordance with a specific implementation, the biometric authentication device is a portable unit. In yet another specific implementation, the biometric authentication device is a hand-held portable unit. In such implementations, the biometric authentication device will typically include a suitable power source such as a battery for example. It will however be appreciated that, in alternative embodiments, the biometric authentication device may be fixed in a console or other non-portable entity.

In accordance with a specific implementation, the third interface of the biometric authentication device comprises an illumination device for illuminating the machine readable zone and an image capturing device for obtaining the signal derived from the machine readable zone (MRZ). The signal derived from the MRZ is indicative of an image capture of the machine readable zone located on the medium carried by the person. The processing unit of the biometric authentication device is operative for processing the image capture to derive the access information. In a specific example, the processing unit applies an optical character recognition (OCR) process to the image capture in order to derive the access information.

In accordance with a specific implementation, the live biometric signal received at the first interface may convey any suitable biometric information associated to a person, including but not limited to: a fingerprint, retinal information, iris information, DNA information, facial recognition information and voice recognition information. In a specific implementation where the live biometric signal conveys a fingerprint associated to the person, the biometric authentication device includes a fingerprint scanner adapted for receiving thereon at least a portion of a person finger to obtain fingerprint information.

In accordance with a specific implementation, the second interface includes a contactless chip reader adapted for receiving signals from a contactless chip. For the purpose of this specification, the expression “contactless chip” is used to broadly describe an entity including an electronic chip capable of storing data contained thereon and of transferring that data to another entity via a wireless connection. The wireless connection is typically a radio-frequency (RF) connection although other types of wireless connections may also be used. Such contactless chips may be included in devices such as smart cards, ID tags, travel documents and access cards to name a few.

In accordance with a specific implementation, the processing unit compares at least a portion of the information stored on the electronic chip with the live biometric signal associated to the person in order to derive the authentication information associated to the person.

In a specific implementation, the information stored on the electronic chip conveys nominative information in addition to biometric data. Such nominative information may include, without being limited to, a person's name, birthday, address, citizenship, passport number, driver's license and any other information that may be of interest depending on the specific application.

In accordance with another broad aspect, the invention provides a method for providing authentication information associated to a person for use in a biometric authentication device of the type described above. The method comprises receiving a live biometric signal associated to the person. The method also comprises obtaining access information from a signal derived from a machine readable zone located on a medium associated to the person. The method also comprises extracting information stored on an electronic chip associated with the person at least in part on the basis of the access information. The method also comprises deriving authentication information associated to the person at least in part on the basis of the information stored on the electronic chip and the live biometric signal.

In accordance with another broad aspect, the invention provides computer readable storage medium including a program element suitable for execution by a computing apparatus for providing authentication information associated to a person in accordance with the above-described method.

In accordance with a broad aspect, the present invention provides a biometric authentication device comprising means for receiving a live biometric signal associated to a person and means for receiving information from an electronic chip associated to the person. The biometric authentication device also comprises means for obtaining a signal derived from a machine readable zone located on a medium carried by the person. The biometric authentication device also comprises means for processing the signal derived from the machine readable zone located on the medium carried by the person to derive access information and means for extracting information stored on the electronic chip at least in part on the basis of the access information. The biometric authentication device also comprises means for deriving authentication information associated to the person at least in part on the basis of the information stored on the electronic chip and the live biometric signal and means for releasing a signal conveying the authentication information.

In accordance with yet another broad aspect, the invention provides a biometric authentication device comprising a first interface, a second interface, a third interface, a processing unit and an output. The first interface is for receiving a live biometric signal associated to a person. The second interface is for receiving information from an electronic chip associated to the person and the third interface for identification information associated to the person. The processing unit is operative for obtaining access information from the identification information associated to the person and for extracting information stored on the electronic chip at least in part on the basis of the access information. The processing unit is also operative for deriving authentication information associated to the person at least in part on the basis of the information stored on the electronic chip and the live biometric signal. The output is for releasing a signal conveying the authentication information.

In accordance with specific examples of implementation, the identification information may be entered manually or via an audio channel. For example, the identification information may be entered via a keypad, a touch sensitive screen, buttons, levers, dials or a voice authentication device.

These and other aspects and features of the present invention will now become apparent to those of ordinary skill in the art upon review of the following description of specific embodiments of the invention and the accompanying drawings.

### BRIEF DESCRIPTION OF THE DRAWINGS

In the accompanying drawings:

FIG. 1 shows a biometric authentication device in accordance with a non-limiting example of implementation of the present invention, shown in proximity to an identification document in the form of a passport;

FIG. 2 shows a functional block diagram of the third interface of the biometric authentication device shown in FIG. 1 in accordance with a specific example of implementation of the present invention;

FIG. 3 shows a functional block diagram of the biometric authentication device shown in FIG. 1 in accordance with a specific example of implementation of the present invention;

FIG. 4 shows a flow diagram of a first non-limiting method for generating authentication information in accordance with a specific example of implementation of the present invention;

FIG. 5 shows a flow diagram of a second non-limiting method for generating authentication information in accordance with another specific example of implementation of the present invention;

FIG. 6 shows a non-limiting example of a plurality of biometric authentication devices in communication with an external entity in accordance with a variant of the present invention; and

FIG. 7 shows a functional block diagram of an external entity in accordance with a non-limiting example of implementation of the present invention.

Other aspects and features of the present invention will become apparent to those ordinarily skilled in the art upon review of the following description of specific embodiments of the invention in conjunction with the accompanying figures.

### DETAILED DESCRIPTION

Authentication Device 10

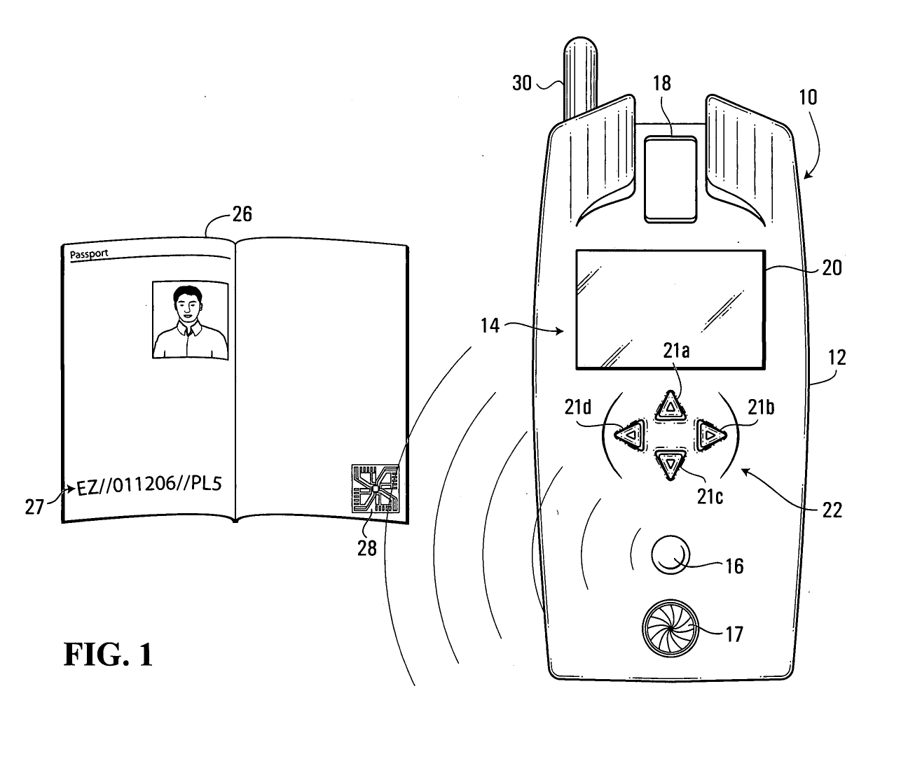

Shown in FIG. 1 is a biometric authentication device 10 in accordance with a non-limiting example of implementation of the present invention. Although the biometric authentication device 10 shown in FIG. 1 is a hand-held portable unit, it should be appreciated that non-portable, stationary units, as well as portable units that are not hand-held, are also included within the scope of the present invention. As will be described in more detail below, the biometric authentication device 10 is suitable for generating authentication information about a person on the basis of received biometric information.

In the non-limiting embodiment shown, the biometric authentication device 10 includes a housing 12 for enclosing electronic circuitry and a battery (not shown). It is the battery that supplies electrical power to the device 10. The housing 12 is preferably of an ergonomically designed shape that is suitable for being carried in the hand of a human operator. However, it should be appreciated that the housing 12 can be of any suitable shape and/or size without departing from the spirit of the invention. The biometric authentication device also includes a user interface 14 located on a front face of the housing 12. The user interface 14 is operative for enabling a user, and/or a person being authenticated, to enter required information and to view information that is conveyed by the device 10.

In the non-limiting embodiment shown, the user interface 14 includes a first interface 18 for receiving live biometric information, a display screen 20, user operable inputs 22, a second interface 16 for receiving stored biometric information from an electronic chip and a third interface 17 for receiving identification information. In the embodiment depicted in FIG. 1, the third interface 17 is operative for obtaining a signal derived from a Machine Readable Zone (MRZ) located on an identification document associated with the person being authenticated. Alternatively, the functionality of the third interface 17 may be performed by the user operable inputs 22 for allowing a user to enter the identification information. Each of these components will be described in more detail below. It should be appreciated that the configuration and layout of the components included in the user interface 14 shown in FIG. 1 have been presented for the purpose of illustration only and can vary from one implementation to the other without departing from the spirit of the invention.

As a variant, the biometric authentication device 10 may further include a fourth interface 30, which in the embodiment shown is in the form of an RF transceiver. As will be described in more detail below, the fourth interface 30 is operative for enabling the biometric authentication device 10 to communicate with one or more entities that are external to the biometric authentication device 10. Depending on the type of communication link established between the biometric authentication device 10 and an external entity, the fourth interface could also be in the form of a USB port, an infrared transceiver, a LAN or WLAN connection, a Bluetooth communications link, or a cellular communications link among others.

In the non-limiting embodiment shown in FIG. 1, the first interface 18 is a fingerprint scanner suitable for capturing a digital representation of a person's fingerprint. More specifically, in the embodiment depicted in FIG. 1, the first interface 18 includes a fingerprint scanner adapted for receiving thereon at least a portion of a person's finger to obtain fingerprint information. However, it should be appreciated that any suitable type of biometric information, such as iris information, retinal information, DNA information, voice recognition information or facial recognition information, could also be used by the biometric authentication device 10 for the purposes of the present invention. As such, depending on the type of biometric information that is used by the biometric authentication device 10, the first interface 18 could be an iris scanner, a retinal scanner, a microphone for obtaining a voiceprint of a person or a camera for obtaining a picture of a person, among other possibilities. In addition, it should be appreciated that the first interface 18 may be operative to obtain more than one type of biometric information such as to allow the biometric authentication device 10 to provide authentication information on the basis of a combination of two or more different types of biometric data. For example, the first interface 18 may be operative to obtain both fingerprint information and iris information, among other possible combinations.

The display screen 20 may be any type of suitable display screen known in the art, such as a CRT screen, an LCD screen or a plasma screen, for example. The display screen 20 is an optional component, and in alternative embodiments of the present invention, a display screen 20 is not included in the biometric authentication device 10. Instead, information can be conveyed to a user via a set of lights, such as for example using LEDs, or via an audio signal, among other possibilities.

The user operable inputs 22 enable a user, or a person being authenticated, to enter information into the biometric authentication device 10. In the embodiment shown, the user operable inputs 22 are in the form of four directional push-buttons 21a-21d. It should be appreciated that the user operable inputs 22 can be in any form suitable for enabling a user to enter information. For example, the user operable inputs 22 may be in the form of push-buttons, levers, dials, a keypad, a touch-sensitive screen, a pointing device or a voice recognition device.

The second interface 16 is operative for receiving electronically stored biometric information from electronic chips associated to different people. The chips may be contained in paper documentation, or in smart cards, for example. In yet a further example, the electronic chips may be contained sub-dermaly within a person, meaning that the chip is implanted under the skin of an individual. In the embodiment shown in FIG. 1, an electronic chip 28 is imbedded within a passport 26 that is associated to a person. The electronic chip 28 contains, amongst other information, stored biometric information associated to the owner of the passport.

In a non-limiting embodiment, in addition to the biometric information, the electronic chip 28 may also contain nominative information, such as a person's name, birthday, address, citizenship, passport number, driver's license and any other information that may be of interest depending on the specific application.

The second interface 16 may be a contact-based chip reader, or a contactless chip reader, without departing from the spirit of the invention. In the case of a contact-based chip reader, the second interface 16 must come into direct physical contact with the chip in order for the chip to transmit the information contained thereon to the reader. Alternatively, in the case where the electronic chip 28 is a contactless chip contained in a medium, such as a contactless smart card or a travel document (e.g. a passport) in which is imbedded an electronic chip, the second interface 16 does not need to come into physical contact with the chip in order to obtain the information stored thereon. Instead, the reader must simply come into physical proximity with the chip. Contactless smart cards are known in the art, and generally include a microcontroller or equivalent intelligence, internal memory and a small antenna embedded within the plastic body of the card for communicating with a reader through a contactless radio frequency (RF) interface. The information contained in the smart card is stored on the electronic chip. When the smart card is placed within a magnetic or electromagnetic field of a smart card reader, the magnetic or electromagnetic field powers the card and causes the data stored in the chip to be exchanged with the reader. More specifically, when the card is brought into the electromagnetic field of the reader, the chip in the card is powered on, and a wireless communication protocol is initiated and established between the card and the reader for data transfer.

In the embodiment shown in FIG. 1, the second interface 16 is a contactless electronic chip reader 16 that is suitable for emitting an electromagnetic field, such that it is able to power on and exchange information with electronic chips contained in smart cards and/or other mediums. Although the second interface 16 shown in FIG. 1 includes only one reader, it should be appreciated that any number of different readers could be included within the biometric authentication device 10 without departing from the spirit of the present invention. For example, multiple readers each emitting a different frequency may be provided in order to be able to accommodate chips that are activated by different frequencies.

In accordance with the new standards set out by the ICAO, the biometric information, and optionally the nominative information, stored on the electronic chip is protected or encrypted such that it can only be accessed by providing a password or key. In accordance with the present invention, the authentication device 10 is operative for obtaining access information, which acts as the password or key, on the basis identification information found on an identification document. The identification document can be any one of a plurality of different kinds of documents, such as a passport, a driver's license, a travel document, a birth certificate, a travel visa or a credit card, among other possibilities. Likewise, depending on the identification document, the identification information found thereon can be a passport number, a visa number, a driver's license number, a bar code or a credit card number, among other possibilities.

The password or key that is used to access the information contained on the electronic chip 28 may be the actual identification information found on the identification document, or alternatively the password or key may be obtained by performing a processing operation on the identification information found on the document. For example, in the case where the identification document is a passport, the password may be the passport number per se, or alternatively, the password may be derived by applying an algorithm, or other processing function, to the passport number.

As will be described in more detail below, the authentication device 10 of the present invention is operative to obtain and use the identification information contained on the identification document in order to derive access information for extracting the protected or encrypted information that is stored on the electronic chip. The authentication device 10 is then operative to generate authentication information on the basis of the stored biometric information associated to the person, and the live biometric signal supplied by the person at the first interface 18.

In accordance with the present invention, the authentication device 10 can obtain the identification information from the identification document in one of two ways:
1) In accordance with a first non-limiting example, the identification information is stored in a machine readable zone (MRZ) of the identification document. As such, the authentication device 10 includes a third interface 17, such as that shown in FIG. 1, that is suitable for obtaining a signal derived from the machine readable zone of the identification document where the signal conveys a representation of the identification information.
2) Alternatively, in accordance with a second non-limiting example, the identification information from the identification document is entered into the authentication device 10 directly by a user of the authentication device. In this embodiment, the authentication device includes a third interface (not shown) that is suitable for enabling the identification information to be entered manually, via a keypad, or verbally, via a voice recognition device, for example. In this embodiment, the identification information does not need to be contained in a machine readable zone of the identification document. In a specific implementation, a separate third interface may be omitted and the functionality of the third interface is performed by the user operable inputs 22 shown in FIG. 1. Alternatively, a separate interface may be provided for supplying the identification information.
   Each of these approaches will now be described in more detail below.
   Interface for Reading a Machine Readable Zone

Shown in FIG. 1 is a non-limiting example of a biometric authentication device 10 that includes a third interface 17 suitable for obtaining a signal derived from a machine readable zone of an identification document. The purpose of obtaining a signal derived from the machine readable zone of the identification document is to obtain a representation of the identification information contained within the machine readable zone. The representation of the identification information contained within the machine readable zone can then be processed to extract therefrom the identification information. For example, where the MRZ includes alpha-numeric type information, the representation of the identification information can be processed using well-known optical character recognition (OCR) algorithms to extract the identification information. In another example where the MRZ includes bar-code type information, the representation of the identification information can be processed using well-known methods to extract the information stored in the bar-code.

In the non-limiting example shown in FIG. 1, the identification document that is being presented by an individual is a passport 26, and the identification information that is contained in the machine readable zone of the passport is the passport number 27. Although the electronic chip 28 is shown as being located in the same document as the identification information that is required to access the electronic chip, it should be understood that the electronic chip 28 may alternatively be located separately from the identification document containing the identification information. For example, the electronic chip may be contained in a smart card or may be may be contained sub-dermaly on the individual, and the information required to access the electronic chip may be contained in a machine readable zone of a birth certificate or passport, for example.

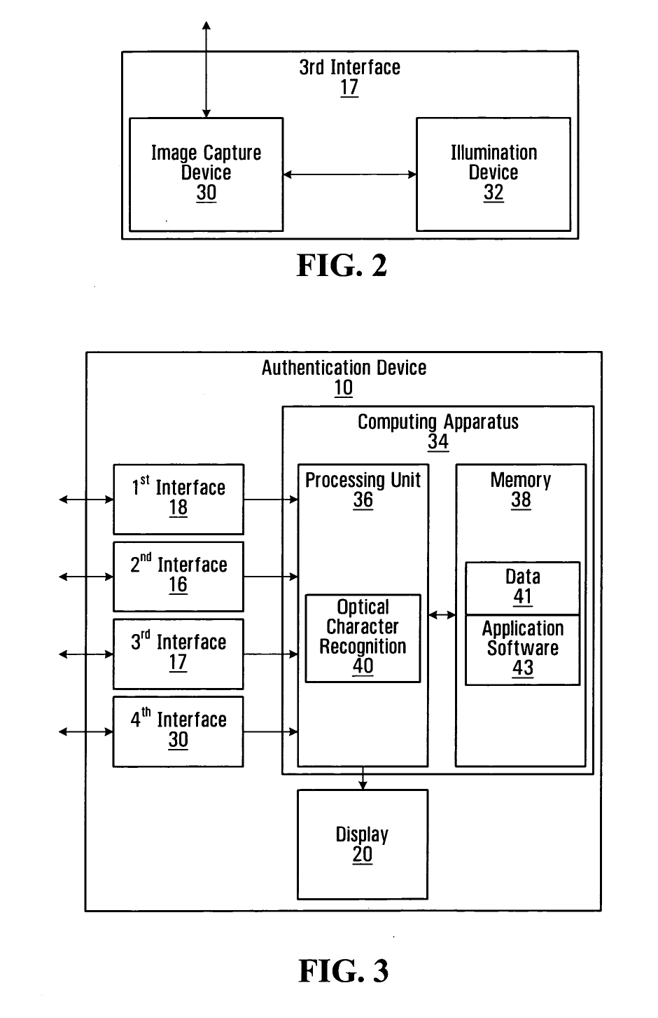

Shown in FIG. 2 is an expanded block diagram of the third interface 17 in accordance with a non-limiting example of implementation of the present invention. As shown, the third interface 17 comprises an image capturing device 30 and an illumination device 32. The illumination device 32 is operative for illuminating the machine readable zone of the identification document, and the image capturing device 30 is operative for obtaining a signal derived from the machine readable zone while it is being illuminated. The signal derived from the machine readable zone is, in a specific example of implementation, an image capture of the machine readable zone.

In accordance with a non-limiting example of implementation, the image capturing device 17 includes a camera suitable for taking an image capture of the machine readable zone. However, it should be appreciated that the image capturing device 17 may alternatively include an image scanner, bar code reader, or other device capable of deriving a signal from the machine readable zone is also included within the scope of the present application.

Typically, portable devices incorporating cameras for obtaining image captures of machine readable zones in documents are highly susceptible to “jitter” effects. This is due in part to the fact that in order to obtain an image capture, the user has to hold the document containing the machine readable zone in one hand and the portable device in the other hand, both at the same time. This often leads to erratic motion and “jitter”, which makes the task of capturing a good image of the MRZ for the purposes of extracting therefrom identification information, using OCR or bar-code reading for example, difficult.

In order to reduce these jitter effects, and obtain a good image capture of the MRZ, the image capturing device 17 preferably includes fast optics and a sensitive imaging scanner that leads to short exposure times. The time period is desirably sufficiently short to obtain a clear image of the MRZ portion of a travel document being manually displaced under the camera during the image capture. Preferably, the image capturing device 30 includes a CMOS based sensor. The use of a CMOS based sensor has the additional advantage of being low on voltage and low on power, and thus would not consume too much battery power.

As described above, the illumination device 32 can be any suitable illumination device known in the art, such as a conventional camera flash, for example. However, in a specific example of implementation, the illumination device 32 is operative for emitting infrared light. An advantage of illuminating the machine readable zone via infrared light is that CMOS sensors are sensitive to infrared light. Although infra-red illumination will distort the colors of the MRZ of the document, this will usually not be of concern for the purpose of extracting identification information from the MRZ. More specifically, algorithms used in performing OCR or bar-code reading typically rely at least in part on contrasts in an image to extract information therefrom. As such, even if the infra-red light distorts the color scheme of the MRZ, the image capture generated using infra-red illumination will typically provide a good image for the purpose of extracting information provided the algorithms used rely at least in part on contrasts to extract that information. In a specific example of implementation, the illumination device 32 includes one or more infrared light emitting diodes for emitting infrared light. The use of infrared light emitting diodes has the advantage of consuming less power than more conventional illumination devices might, and as such requires less power from the battery of the authentication device. It is generally considered desirable to limit the amount of power consumption in battery operated devices, since doing so extends battery life and therefore extends the amount of time the device can be used “in-the-field” without requiring the battery to be recharged or replaced. In addition, the infrared light emitting diodes ensure proper illumination of the identification document so that it can be read in daylight or total darkness. As such, the combination of the CMOS sensors and the infrared light emitting diodes provide a low power, effective way of taking image captures of a machine readable zone of a document.

Functional Block Diagram

Shown in FIG. 3 is a functional block diagram of the biometric authentication device 10 of FIG. 1. In addition to the first interface 18, the second interface 16, the third interface 17 and the display 20, the biometric authentication device 10 further includes a computing apparatus 34 that includes a processing unit 36 and a memory 38. As will be described in more detail below, the processing unit 36 is operative for processing the information received from the first interface 18, the second interface 16 and the third interface 17 in order to generate authentication information.

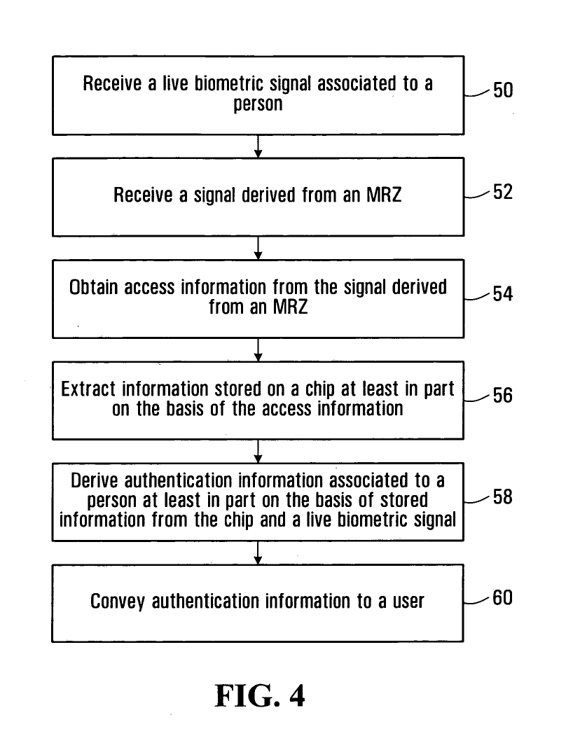

In the specific example of implementation depicted in FIG. 3, the processing unit 36 includes, amongst other components, an optical character recognition module 40, and the memory 38 includes data 41 and application software 43 adapted to be executed by the processing unit 36. The manner in which the processing unit 36 uses the optical character recognition module 40 and the data 41 and application software 43 to generate the authentication information will now be described in more detail with respect to the flow diagram shown in FIG. 4.

Method of FIG. 4

In order to authenticate an individual having identification documentation with a machine readable zone and an electronic chip containing stored biometric information, the processing unit 36 of the authentication device performs the following method.

Firstly, at step 50 the processing unit 36 receives from the first interface 18 a live biometric signal. For the purposes of the present application, the live biometric signal will be a digital representation of a person's fingerprint. As such, when a person places his or her fingerprint on the first interface 18 (i.e. the fingerprint scanner) the fingerprint scanner captures a digital representation of the person's fingerprint, and transmits that signal to the processing unit 36 (shown in FIG. 3). Although this step is being described first, as will be described further on in the specification, this step is not necessarily the first step in the process.

At step 52, the processing unit 36 receives from the third interface 17 a signal derived from the machine readable zone of the identification document. As described above, the signal derived from the MRZ is preferably an image capture of the identification information contained in the MRZ. Referring to FIG. 3, this signal derived from the machine readable zone that is obtained by the third interface 17 is sent from the third interface 17 to the processing unit 36.

At step 54, the processing unit 36 processes the signal derived from the machine readable zone in order to derive access information. It is the access information that will act as the password or key to allow the authentication device 10 to extract information from an associated electronic chip 28. As shown in FIG. 3, the processing unit 36 includes an optical character recognition unit 40. In accordance with a non-limiting example of implementation, the processing unit 36 uses the optical character recognition unit 40 in order to apply an optical character recognition process to the image capture. By so doing, the processing unit is able to extract the passport number, or other piece of identification information, from the image capture of the MRZ.

As described above, the access information may simply be the passport number as recognised from the image capture of the MRZ. In such a case, the only processing of the signal derived from the MRZ is the optical character recognition process so as to identify the numbers, letters and/or other alphanumeric symbols contained in the MRZ.

Alternatively, once the processing unit 36 has used the optical character recognition unit 40 to identify the alphanumeric symbols of the passport number, the processing unit 36 may then apply further algorithms or processing techniques to the passport number in order to derive the access information. For example, the access information may be a coded version of the passport number. The algorithm for deriving the access information therefore acts as an additional security measure for safeguarding the information stored on the electronic chip.

In an alternative example, in the case where the identification information contained in the machine readable zone is a bar code, the processing unit 36 will apply suitable bar code deciphering algorithms to the image capture, in order to derive access information. In such an implementation, the optical character recognition unit 40 may be omitted from the processing unit 36 and replaced by a suitable bar code deciphering unit (not shown in the figures).

At step 56, once the processing unit 36 has obtained the access information, it then uses this access information in order to extract the biometric information, and possibly the nominative information, stored on the electronic chip 28.

The manner in which the processing unit 36 extracts information from the electronic chip 28 using the access information can be done in different ways.

In accordance with a first example, the second interface 16 (i.e. the chip reader) continually emits an electromagnetic field for powering on the electronic chip, but it is not until the processing unit 36 has obtained the access information that the electromagnetic field emitted actually causes the electronic chip 28 to transfer its stored information to the authentication device 10. In such an implementation, the electronic chip 28 is programmed to release the information contained thereon upon receipt of the access information, the latter acting as a key to “unlock” the electronic chip 28. As such, by obtaining the access information at the processing unit 36, the second interface 16 is able to extract the information stored on electronic chip 28.

In accordance with a second example, the second interface 16 (i.e. the chip reader) continually emits an electromagnetic field for powering on the electronic chip 28 and for receiving from the electronic chip encrypted or protected data that is stored on the chip 28. As such, even though the second interface 16 is able to receive data from the electronic chip, it is unable to extract the stored biometric, and possibly nominative, information from the chip 28, until the processing unit 36 has obtained the access information. As such, the data in the encrypted or protected format can be stored in the memory unit 38 while the processing unit 36 obtains the access information needed to extract the information. Once the processing unit 36 has obtained the access information as described in step 54, the processing unit 36 then retrieves the data from the memory unit 38 and applies the access information to the data for extracting from this data the biometric, and possibly nominative, information stored thereon.

At step 58, once the processing unit 36 has extracted the stored biometric information from the electronic chip, and has received a live biometric signal from the first interface 18, the processing unit 36 makes use of the application software 43 contained in the memory 38 to process the stored biometric information extracted from the electronic chip. In accordance with a non-limiting example of implementation, the application software is operative to compare the stored biometric information from the electronic chip with the live biometric signal in order to derive authentication information associated to the person. More specifically, in the case where the stored biometric information and the live biometric signal match, then the authentication information is indicative that the passport does belong to the holder of the passport. Whereas, in the case where the stored biometric information and the live biometric signal do not match, then the user of the authentication device 10 can conclude that the passport possibly does not belong to he person presenting the passport, and can then act accordingly.

Although step 50, which involves receiving the live biometric signal is shown as occurring prior to receiving a signal derived from the MRZ, it may not be necessary to receive the live biometric signal until after the processing unit 32 has obtained the access information and extracted the stored biometric information from the electronic chip 28. As such, step 50 may not occur until after step 56. In such a situation, the biometric authentication device 10 may use the display 20 to prompt a person to put his or her fingerprint on the fingerprint scanner 18, after the processing unit 36 has completed step 56.

The application software 43 may include any type of program instructions suitable for causing the processing unit 36 to generate authentication information. In addition, it should be appreciated that the authentication information may take on many different forms. For example, the authentication information may be indicative that the live biometric signal and the stored biometric information extracted from the electronic chip match. The authentication information may also indicate a level of confidence for the match. For example, the authentication information may indicate that there is a match at a level of confidence of 95%. Any suitable algorithm for deriving authentication information on the basis of biometric information may be used without detracting from the spirit of the invention. The specific process applied by the application software is not critical to the present application and as such will not be described further here.

As a variant, the authentication information may indicate that the person who presented the electronic chip is an authorised person, or has some sort of authorised status. Alternatively, the authentication information may indicate that the person is a banned individual, or that the person is on some alert list, such as a watch list. For example, where the biometric authentication device is used in an area where the access is restricted, the authentication information may indicate whether the person is authorised to be in that restricted area. In yet a further alternative, the authentication information may be indicative of nominative information associated with the person being authenticated or other additional information. The nominative information may include, for example, the person's name, birth date and picture. In such circumstances, the data 41 stored in the biometric authentication device 10 may include a database storing information indicative of a list of authorised people, unauthorised people, and/or information such as the name and birth date associated with authorised people. Alternatively, and as will be described in more detail below, such information may be stored on an external entity that the biometric authentication device 10 is adapted for accessing for extracting certain supplemental information therefrom.

Once the authentication information has been derived, the method proceeds to step 60, wherein the authentication information generated by the processing unit 36 is conveyed to a user. This may be done in a variety of different ways. For example, the authentication information may be conveyed via text or pictograms presented on the display screen 20. Alternatively, the authentication information may be conveyed via flashing lights, a beeping sound, or synthesised speech, among other possibilities. For example, in the case where the authentication information generated by the biometric authentication device 10 is indicative that the live biometric signal matches the stored biometric information, this information may be presented to a user via a flashing light. As such, once a user sees that a light has started to flash, the user will know that the person being screened has been authenticated. In an alternative example, in the case where the authentication information generated by the biometric authentication device 10 is indicative that the live biometric signal matches the stored biometric information, this information may be presented to a user via a green light. Conversely, where the authentication information generated by the biometric authentication device 10 is indicative that the live biometric signal does not match, this information may be presented to a user via a red light. The person skilled in the art will appreciate, in light of the present description, that there are a number of different manners in which the authentication information may be conveyed to a user and that the above described examples have been presented for the purpose of illustration only.

User Input of Identification Information

As described above, in an alternative embodiment of the present invention, instead of obtaining the identification information via a third interface 17 that is operative to derive a signal from a machine readable zone of a document, the authentication device 10 includes a third interface for enabling a user to enter the identification information into the authentication device 10. The third interface may include any suitable device for enabling the user to provide the identification information. For example, the third interface may include a keypad, buttons, dials, a touch sensitive screen or a voice recognition device.

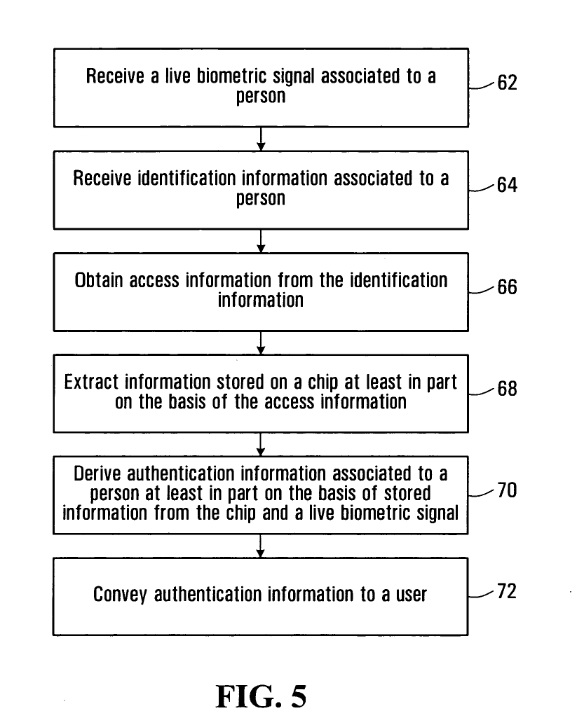

Shown in FIG. 5 is a non-limiting example of a method for generating authentication information wherein the identification information is entered by a user of the authentication device 10.

Firstly, at step 62 the processing unit 36 receives from the first interface 18 a live biometric signal. As described above with respect to the method of FIG. 4, for the purposes of the present application, the live biometric signal will be a digital representation of a person's fingerprint. Although this step is being described first, as will be described further on in the specification, this step is not necessarily the first step in the process.

At step 64, the processing unit 36 receives the identification information associated to a person. This information is entered by a user of the authentication device 10 via a third interface, which in accordance with this embodiment, may be a keypad, buttons, a touch sensitive screen or a voice recognition device, among other possibilities. As such, referring to FIG. 1, the third interface may include the user operable inputs 22.

In order to enter the identification information, the user of the authentication device 10 will look at the identification document presented by an individual in order to find the appropriate identification information. For example, in the case of a passport 26, the user will open the passport in order to find the passport number. The user will then enter this information into the device manually or verbally via the third interface.

At step 66, the processing unit obtains access information on the basis of the entered identification information. This access information will act as the password or key to allow the authentication device 10 to extract information from an associated electronic chip 28. As described above, the access information may simply be the identification information, such as the passport number, entered by the user. Or alternatively, once the identification information has been entered, the processing unit 36 may apply an algorithm, or other processing technique, to the entered information in order to derive the access information.

At step 68, once the processing unit 36 has obtained the access information, it then uses this access information to extract the biometric information, and possibly the nominative information, stored on the electronic chip 28. This may be done in the same manner as described above with respect to step 56 of FIG. 4.

At steps 70 and 72 the processing unit 36 derives authentication information associated to the person at least in part on the basis of the extracted information from the electronic chip 28 and the live biometric signal received at the first interface 18, and then coveys this authentication information to a user. Steps 70 and 72 are performed in the same way as steps 58 and 60 described above with respect to FIG. 4.

Both Options

In accordance with yet another alternative embodiment, the authentication device 10 may be operative to obtain the identification information via both an interface that can derive a signal from a machine readable zone, such as third interface 17 shown in FIG. 1, and from an interface that enables a user to enter the identification information. This would provide a more versatile authentication device 10, since it would provide the user of the authentication device 10 with choice as to how to enter the identification information. For example, the default setting of the authentication device 10 may be to use the third interface 17 to obtain the identification information (i.e. to take an image capture of the identification information in the machine readable zone of the identification document). However, in the case where the identification document is dirty, or has been deformed, such that the third interface 17 is unable to obtain a good image capture of the machine readable zone, then the user can have the choice to switch to entering the identification information into the authentication device his/herself.

Alternatively and in accordance with a non-limiting example, the processing unit 36 may be operative to detect when the signals derived from the machine readable zone are inadequate. Upon detection that it is unable to process these signals in order to obtain the access information, the processing unit 36 may generate a signal to be displayed on the display screen 20, advising the user that they should manually (or verbally) enter the identification information into the authentication device 10.

External Entity

In accordance with a non-limiting example of implementation, the authentication device 10 may by operative to communicate with one or more external entities that are distinct from the authentication device 10. For example, the external entities may be external data storage entities, or they may be external computing entities. These external entities are operative for providing the authentication device 10 with supplemental data that may be used in order to help derive authentication information, or that may be used in connection with other processing functions performed by the authentication device 10.

For example, the authentication device 10 may be operative for establishing a communication link with a stand alone external data storage entity, such as a CD drive, a memory wand, an external hard drive, etc. . . . Such a communication link may be a wire link, such as via a USB cable, or a wireless link, such as an RF or infrared link. As such, in the case where the authentication device 10 needs to be updated, or requires additional information that is not stored in its memory unit 38, the user of the authentication device 10 may establish a communication link between the authentication device 10 and the storage device so as to obtain the supplemental information contained on the storage device. The supplemental information may include a watch list, a criminal list, a list of banned individuals, information associated to a specific person, biometric information, program elements and another other type of useful information.

In the case where the supplemental information includes a list of banned individuals, once the authentication device has confirmed that the person who has presented the identification documentation is in fact the owner of that documentation, the authentication device may compare that person with a list of banned individuals. Alternatively, the authentication device 10 may compare that person with information associated to that specific person, such as a picture for example. In the case where there is a match between the person recognised and the list of banned individuals, the user of the authentication device proceeds in performing the required procedure to address the situation such as, for example, removing the banned individual from the secure location.

In the case where the supplemental information includes information suitable for extracting information stored on a chip, this supplemental information may include a new algorithm for processing the signal derived from the machine readable zone. Alternatively, the information may be a database containing a plurality of entries; each entry comprising identification information and associated access information. As such, once the processing unit 36 has received the identification information from the signal derived from the MRZ, or entered by a user, the processing unit 36 can then access the database in order to look up the access information that corresponds to that identification information.

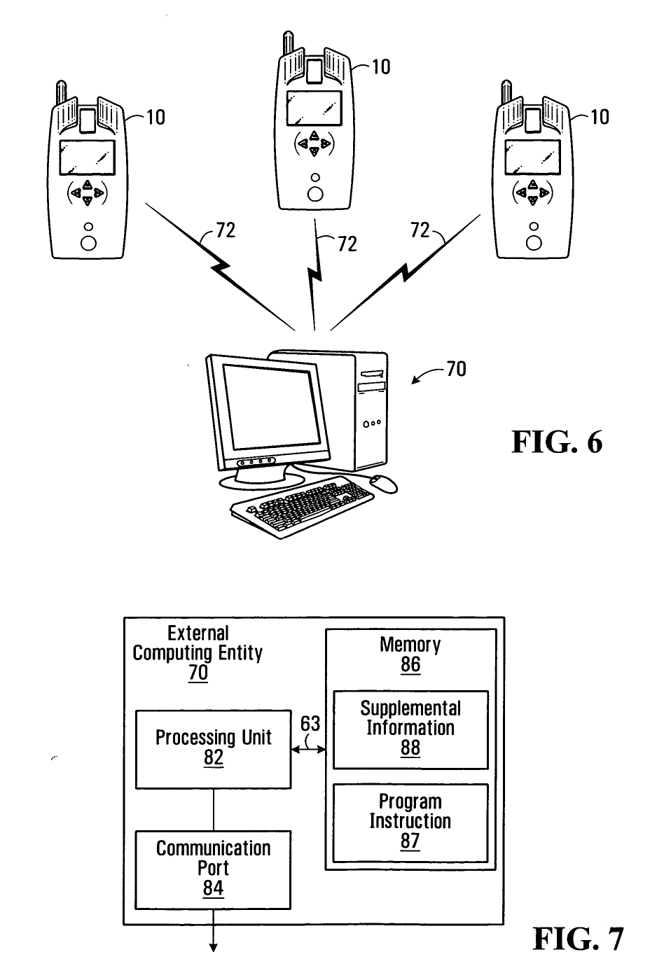

Alternatively, the authentication device 10 may be operative to establish a communication link with an external computing entity for receiving the supplemental information. Shown in FIG. 6 is an external computing entity 70 that is suitable for establishing respective communication links 72 with a plurality of portable biometric authentication devices 10. The external computing entity 70 can be any form of computing entity that can exchange information with one or more biometric authentication devices 10 over a communication link.

In the embodiment shown in FIG. 6, the communication links 72 between the biometric authentication devices 10 and the external entity 70 are wireless RF links. It should, however, be appreciated that each biometric authentication device 10 may communicate with the external entity 70 via other types of communication links, such as wireless IR links, or via wireline links, for example. The biometric authentication device 10 may also be connected to an external computing entity over a network arrangement, such as over an intranet, or over the Internet.

Shown in FIG. 7 is a functional block diagram of an external computing entity 70 in accordance with a specific embodiment of the present invention. As shown, the external entity 70 includes a communication port 84, a processing unit 82 and a memory 86 for storing supplemental information 88 and program instructions 87.

The communication port 84 is operative for establishing a communication link with a biometric authentication device 10 via the fourth interface 30 of the biometric authentication device 10 (shown in FIGS. 1 & 2). Depending on the type of communication link 72 that can be established between the external computing entity 70 and the biometric authentication devices 10, the communication port 84 can be a USB port, an RF transceiver, an infrared (IR) transceiver, or any other suitable communication port known in the art. In addition, the communication port 84 can be comprised of separate input and output ports, or alternatively, the communication port 84 may be a combined input/output port.

The supplemental information 88 stored at the computing entity 70 may be transferred to the authentication device 10 in a variety of different ways. In accordance with a first non-limiting example, when the authentication device 10 detects that it does not have the information it needs to derive the access information, generate the authentication information or perform any other desired processing operation, the authentication device 10 initiates communication with the external entity 70 in order to retrieve the supplemental information it requires from the external entity 70. This form of up-dating is referred to as “on-the-fly” updating, wherein the update is only performed if and when the biometric authentication device 10 needs the updated information.

Advantageously, since the biometric authentication device 10 is adapted to communicate with the external computing entity 70 when certain information is detected as being absent from its memory 38, the biometric authentication device 10 need not be brought in for servicing to update the data 41 stored in its memory each time new information is introduced into the system. Advantageously, this allows a reduction in the amount of idle time spent by the biometric authentication devices 10 since they do not need to be taken out of service to be updated.

In such an embodiment, the processing unit 32 of the authentication device 10 may transmit a signal to the processing unit 82 of the external computing entity 70, for requesting that the external entity 70 transfer the supplemental information from its memory 86 to the biometric authentication device 10 over a communication link 72. As described above, such a communication link 72 may be an RF, IR link or a wireline communication link. Suitable hand-shaking protocols may be used for establishing the communication link for allowing the biometric authentication device 10 to receive the requested supplemental information.

Optionally, the external entity may preemptively issue a signal to the authentication device 10 asking the authentication device 10 whether it requires certain supplemental information. For example, the biometric authentication device 10 receives via its fourth interface 30 (shown in FIGS. 1 & 3) certain supplemental information, such as a new banned individuals list, from the external computing entity 70. Such information is generated by the processing unit 82 of the external entity 70 (shown in FIG. 7) and is released from the communication port 84 towards one or more biometric authentication devices 10.

Upon receipt of such a signal, the processing unit 36 of the biometric authentication device 10 determines whether this information is already stored in its memory 38. This may be done by comparing the information received from the external entity 70 with the data 41 contained in the memory 38.

In the case where the processing unit 36 determines that it already has the information received, then the processing unit 36 essentially ignores the information received from the external entity 70, and does nothing. Alternatively, in the case where the processing unit 36 determines that it does not have the information received, then it updates the data 41 stored in its memory to include this information.

In a variant, the biometric authentication device 10 is adapted for periodically establishing a communication link with an external computing entity 70 for prompting the latter to transmit new supplemental information. In a non-limiting implementation of this variant, the external computing entity 70 may maintain information conveying the time of the last update associated with the specific biometric authentication device 10. Upon receipt of a signal from the specific biometric authentication device 10, the external computing entity 70 is adapted for transmitting to the specific biometric authentication device 10 new supplemental information that was subsequent to the time of the last update. The external computing entity 70 is also adapted for updating the time of the last update associated to the specific biometric authentication device 10.

The frequency at which the biometric authentication device 10 establishes a communication link with external computing entity 7060 may vary from one implementation to the other and is not critical to the invention. In addition, the communication link between the biometric authentication device 10 and the external computing entity 60 may be established at regular or irregular time intervals. Alternatively, the communication link between the biometric authentication device 10 and the external computing entity 60 may be established when the biometric authentication device 10 remains idle for a certain period of time. Advantageously, this alternative allows taking advantage of the biometric authentication device's idle time to keep the supplemental information up to date.

It will be appreciated that the external computing entity 70 may also be of a distributed nature where the request for supplemental information from one or more authentication devices 10 is collected at one location and is then transmitted over a network to a server unit storing the supplemental information 88 and the program instructions 87. The server unit may then transmit a signal for conveying the supplemental information over the network.

A plurality of biometric authentication devices 10 may be connected to the server unit through a network. The communication links between the plurality of biometric authentication devices 10 and the server unit can be metallic conductors, optical fibers or wireless, without departing from the spirit of the invention. The network may be any suitable network including but not limited to a global public network such as the Intranet, a private network and a wireless network. The server may be adapted to process signals requesting conversion instructions, and issue signals for releasing supplemental information concurrently using suitable methods known in the computer related arts.

Specific Practical Implementation

Those skilled in the art should appreciate that in some embodiments of the invention, all or part of the functionality previously described herein with respect to the biometric authentication device 10 may be implemented as pre-programmed hardware or firmware elements (e.g., application specific integrated circuits (ASICs), electrically erasable programmable read-only memories (EEPROMs), etc.), or other related components.

In other embodiments of the invention, all or part of the functionality previously described herein with respect to the biometric authentication device 10 may be implemented as software consisting of a series of instructions for execution by a computing unit. The series of instructions could be stored on a medium which is fixed, tangible and readable directly by the computing unit, (e.g., removable diskette, CD-ROM, ROM, PROM, EPROM or fixed disk), or the instructions could be stored remotely but transmittable to the computing unit via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared or other transmission schemes).

The biometric authentication device 10 may be configured as a computing entity, including a processing unit and a memory connected by a communication bus. The memory includes data, such as the supplemental information, and the program instructions. The processing unit is adapted to process the supplemental information and the program instructions in order to implement the process described above.

Although the present invention has been described in considerable detail with reference to certain preferred embodiments thereof, variations and refinements are possible without departing from the spirit of the invention. Therefore, the scope of the invention should be limited only by the appended claims and their equivalents.

1. In a portable biometric authentication device, a method for providing authentication information associated to a person, the method comprising:
a) receiving a live biometric signal associated to the person;
b) obtaining access information from a signal derived from a machine readable zone located on a medium associated to the person;
c) extracting information stored on an electronic chip associated with the person at least in part on the basis of the access information;
d) deriving authentication information associated to the person at least in part on the basis of the information stored on the electronic chip and the live biometric signal received in a).

2. A method as defined in claim 1, wherein obtaining the access information comprises
a) obtaining an image capture of the machine readable zone located on the medium carried by the person;
b) processing the image capture to derive the access information.

3. A method as defined in claim 2, wherein processing the image capture includes applying an optical character recognition (OCR) process to the image capture.

4. A method as defined in claim 2, wherein obtaining the image capture of the machine readable zone located on the medium carried by the person comprises:
a) illuminating the machine readable zone;
b) taking an image capture of the machine readable zone using an image capturing device.

5. A method as defined in claim 4, wherein the image capturing device includes a camera.

6. A method as defined in claim 5, wherein the camera includes a CMOS based sensor.

7. A method as defined in claim 5, wherein the camera has a short exposure time.

8. A method as defined in claim 4, wherein the machine readable zone is illuminated using an infra-red (IR) light source.

9. A method as defined in claim 8, wherein the infra-red (IR) light source includes at least one light emitting diode (LED).

10. A method as defined in claim 1, said method comprising releasing a signal conveying the authentication information.

11. A method as defined in claim 1, wherein the live biometric signal conveys at least one of fingerprint information, DNA information, retinal information, iris information, facial recognition information and voice recognition information.

12. A method as defined in claim 11, wherein the information stored on the electronic chip is indicative of stored data associated to at least one of fingerprint information, DNA information, retinal information, iris information, facial recognition information and voice recognition information.

13. A method as defined in claim 1, wherein deriving authentication information associated to the person comprises comparing the information stored on the electronic chip with the live biometric signal associated to the person.

14. A method as defined in claim 1, wherein the medium associated to the person is selected from the set consisting of an identification document, a passport, a driver's license, a travel document, a travel visa and a credit card.

15. A method as defined in claim 1, wherein the machine readable zone comprises one of a passport number, a visa number, a driver's license number, a bar code and a credit card number.

16. A method as defined in claim 1, wherein the electronic chip is a contactless chip.

17. A method as defined in claim 1, wherein said authentication information is indicative of one of a positive identification of the person and a negative identification of the person.

18. A method as defined in claim 2, said method further comprising establishing a communication link with an entity external to the authentication device for receiving supplemental information.

19. A method as defined in claim 18, wherein said supplemental information includes at least one of a list of banned individuals, information associated to a specific person, biometric information and information suitable for extracting information stored on the electronic chip.

20. A method as defined in claim 18, wherein said communication link is a wireless communication link.

21. A method as defined in claim 20, wherein said wireless communication link is one of an RF link and an IR link.

22. A method as defined in claim 1, wherein the information stored on the electronic chip conveys nominative information and biometric data.

23. A method as defined in claim 22, wherein said nominative information includes at least one item of information selected from the set consisting of a name, birthday, address, citizenship, passport number and driver's license number.

24. A biometric authentication device, comprising:
a) a first interface for receiving a live biometric signal associated to a person;
b) a second interface for receiving information from an electronic chip associated to the person;
c) a third interface for obtaining a signal derived from a machine readable zone located on a medium carried by the person;
d) a processing unit in communication with said first interface, said second interface and said third interface, said processing unit being operative for:
i. processing the signal derived from the machine readable zone located on the medium carried by the person to derive access information;
ii. extracting information stored on the electronic chip at least in part on the basis of the access information;
iii. deriving authentication information associated to the person at least in part on the basis of the information stored on the electronic chip and the live biometric signal;
e) an output for releasing a signal conveying the authentication information.

25. A biometric authentication device as defined in claim 24, wherein said biometric authentication device is a portable unit.

26. A biometric authentication device as defined in claim 25, wherein said third interface comprises:
a) an illumination device for illuminating the machine readable zone;
b) an image capturing device for obtaining the signal derived from the machine readable zone, the signal derived being indicative of an image capture of the machine readable zone located on the medium carried by the person;
said processing unit being operative for processing the image capture to derive the access information.

27. A biometric authentication device as defined in claim 26, wherein said processing unit applies an optical character recognition (OCR) process to the image capture in order to derive the access information.

28. A biometric authentication device as defined in claim 26, wherein the image capturing device includes a camera.

29. A biometric authentication device as defined in claim 27, wherein the camera includes a CMOS based sensor.

30. A biometric authentication device as defined in claim 27, wherein the camera has a short exposure time.

31. A biometric authentication device as defined in claim 26, wherein the illumination device includes an infra-red (IR) light source.

32. A biometric authentication device as defined in claim 31, wherein the infra-red (IR) light source includes at least one light emitting diode (LED).

33. A biometric authentication device as defined in claim 25, wherein the live biometric signal conveys at least one of fingerprint information, DNA information, retinal information, iris information, facial recognition information and voice recognition information.

34. A biometric authentication device as defined in claim 25, wherein said first interface includes a fingerprint scanner adapted for receiving thereon at least a portion of a person's finger to obtain fingerprint information.

35. A biometric authentication device as defined in claim 25, wherein the information stored on the electronic chip is indicative of stored data associated to at least one of fingerprint information, DNA information, retinal information, iris information, facial recognition information and voice recognition information.

36. A biometric authentication device as defined in claim 25, wherein said second interface includes a contactless chip reader.

37. A biometric authentication device as defined in claim 25, wherein the processing unit compares at least a portion of the information stored on the electronic chip with the live biometric signal associated to the person in order to derive the authentication information associated to the person.

38. A biometric authentication device as defined in claim 25, wherein the medium associated to the person comprises one of an identification document, a passport, a driver's license, a travel document, a travel visa and a credit card.

39. A biometric authentication device as defined in claim 25, wherein the machine readable zone comprises one of a passport number, a visa number, a driver's license number, a bar code and a credit card number.

40. A biometric authentication device as defined in claim 25, said biometric authentication device further comprising a display screen in communication with said output for receiving the signal conveying the authentication information, said signal conveying the authentication information being operative for causing said display screen to display information derived at least in part on the basis of the authentication information.

41. A biometric authentication device as defined in claim 40, wherein said authentication information is indicative of one of a positive identification of the person and a negative identification of the person.

42. A biometric authentication device as defined in claim 25, further comprising a fourth interface for establishing a communication link with an entity external to the biometric authentication device for receiving supplemental information.

43. A biometric authentication device as defined in claim 42, wherein said supplemental information includes at least one of a list of banned individuals, information associated to a specific person, biometric information and information suitable for extracting information stored on the electronic chip.

44. A biometric authentication device as defined in claim 42, wherein said communication link is a wireless communication link.

45. A biometric authentication device as defined in claim 44, wherein said wireless communication link is one of an RF link and an IR link.

46. A biometric authentication device as defined in claim 35, wherein the information stored on the electronic chip conveys nominative information in addition to biometric data.

47. A biometric authentication device as defined in claim 46, wherein said nominative information includes at least one item of information selected from the set consisting of a name, birthday, address, citizenship, passport number and driver's license number.

48. A biometric authentication device as defined in claim 25, further comprising a power source.

49. A biometric authentication device as defined in claim 48, wherein the power source is a battery.

50. A computer readable storage medium including a program element suitable for execution by a computing apparatus for providing authentication information associated to a person, said computing apparatus comprising:
a) a memory unit;
b) a processor in communication with said memory unit, said program element when executing on said processor being operative for:
i. receiving a live biometric signal associated to the person;
ii. receiving information from an electronic chip associated to the person;
iii. receiving a signal derived from a machine readable zone located on a medium associated to the person;
iv. processing the signal derived from the machine readable zone located on the medium carried by the person to derive access information;
v. extracting information stored on the electronic chip at least in part on the basis of the access information;
vi. deriving authentication information associated to the person at least in part on the basis of the information stored on the electronic chip and the live biometric signal.

51. A computer readable storage medium as defined in claim 50, wherein said program element when executing on said processor is further operative for applying an optical character recognition (OCR) process to the signal derived from the machine readable zone for deriving the access information.

52. A computer readable storage medium as defined in claim 50, wherein said program element when executing on said processor is further operative for releasing a signal conveying the authentication information.

53. A computer readable storage medium as defined in claim 50, wherein the live biometric signal conveys at least one of fingerprint information, DNA information, retinal information, iris information, facial recognition information and voice recognition information.

54. A computer readable storage medium as defined in claim 53, wherein the information from the electronic chip is indicative of stored data associated to at least one of fingerprint information, DNA information, retinal information, iris information, facial recognition information and voice recognition information.

55. A computer readable storage medium as defined in claim 54, wherein deriving the authentication information associated to the person comprises comparing the information from the electronic chip with the live biometric signal associated to the person.

56. A computer readable storage medium as defined in claim 50, wherein said authentication information is indicative of one of a positive identification of the person and a negative identification of the person.

57. A computer readable storage medium as defined in claim 50, said program element when executing on said processor being further operative for establishing a communication link with an entity external to the computing apparatus for receiving supplemental information.

58. A computer readable storage medium as defined in claim 57, wherein said supplemental information includes at least one of a list of banned individuals, information associated to a specific person, biometric information and information suitable for extracting information stored on the electronic chip.

59. A computer readable storage medium as defined in claim 57, wherein said communication link is a wireless communication link.

60. A computer readable storage medium as defined in claim 59, wherein said wireless communication link is one of an RF link and an IR link.

61. A computer readable storage medium as defined in claim 50, wherein the information from the electronic chip conveys nominative information in addition to biometric data.

62. A computer readable storage medium as defined in claim 50, wherein said nominative information includes at least one item of information selected from the set consisting of a name, birthday, address, citizenship, passport number and driver's license number.

63. A biometric authentication device comprising;
a) means for receiving a live biometric signal associated to a person;
b) means for receiving information from an electronic chip associated to the person;
c) means for obtaining a signal derived from a machine readable zone located on a medium carried by the person;
d) means for processing the signal derived from the machine readable zone located on the medium carried by the person to derive access information;
e) means for extracting information stored on the electronic chip at least in part on the basis of the access information;
f) means for deriving authentication information associated to the person at least in part on the basis of the information stored on the electronic chip and the live biometric signal;
g) means for releasing a signal conveying the authentication information.

64. A biometric authentication device, comprising:
a) a first interface for receiving a live biometric signal associated to a person;
b) a second interface for receiving information from an electronic chip associated to the person;
c) a third interface for receiving identification information associated to the person;
d) a processing unit in communication with said first interface, said second interface and said third interface, said processing unit being operative for:
i. obtaining access information from the identification information associated to the person;
ii. extracting information stored on the electronic chip at least in part on the basis of the access information;
iii. deriving authentication information associated to the person at least in part on the basis of the information stored on the electronic chip and the live biometric signal;
e) an output for releasing a signal conveying the authentication information.

65. A biometric authentication device as defined in claim 64, wherein the identification information is entered via one of a keypad, a touch sensitive screen, buttons, levers, dials and a voice authentication device.

66. A biometric authentication device as defined in claim 64, wherein the identification information associated to the person is selected from the set consisting of a passport number, a visa number, a driver's license number and a credit card number.

67. A biometric authentication device as defined in claim 64, wherein the live biometric signal conveys at least one of fingerprint information, DNA information, retinal information, iris information, facial recognition information and voice authentication information, and wherein the information stored on the electronic chip is indicative of corresponding stored data associated to at least one of fingerprint information, DNA information, retinal information, iris information, facial recognition information and voice authentication information.
